(19) United States
(12) Patent Application Publication
(10) Pub. No.: US 2010/0180197 A1
(43) Pub. Date: Jul. 15, 2010

(54) TEXT DISPLAY CONTROLLER AND COMPUTER PROGRAM

(75) Inventor: Fumikazu Ohashi, Tokyo (JP)

Correspondence Address: YOUNG & THOMPSON, 209 Madison Street, Suite 500, Alexandria, VA, 22314, US

(73) Assignees: PIONEER CORPORATION, Tokyo (JP); PIONEER SOLUTIONS CORPORATION, Tokyo (JP)

(21) Appl. No.: 12/527,318

(22) PCT Filed: Feb. 16, 2007
(86) PCT No.: PCT/JP2007/052877

§ 371 Date: Dec. 18, 2009

(51) Int. Cl. G06F 17/21

(52) U.S. Cl. 715/256

(57) ABSTRACT

The control device (110) executes the application recorded in the memory device (140) in a personal computer. When text insert mode is selected during the execution of the application, the text input box (200) is set on the application image depending on the user's operation. The application control part (111) of the control device (110) determines text size which is the largest in the area where text height is below the upper limit value from multiple predetermined candidate values of text size as the text size (SZ) suitable for displaying texts. When texts are entered, the application control part (111) controls the display data produce part (113) and the display control part (112) to display texts (TXT) at the determined text size (SZ).

### BACKGROUND OF THE INVENTION

1. Field of the Invention

The present invention relates to a text display control apparatus and a computer program, for example, used for inputting or entering texts on a screen.

2. Description of the Related Art

This kind of apparatus which can display a text or texts in the middle of a display region has been proposed (e.g. refer to Japanese Patent Application Laid Open NO. H05-119762). According to the text input method disclosed in Japanese Patent Application Laid Open NO. H05-119762 (hereinafter referred to as a “related art”), the text display height and the text display width which respectively represent the height and width of the text display region are determined, and the standard text display width in displaying the text with the standard display height is also determined. Then, it is disclosed such that, by displaying texts at the smaller magnification of (i) the display magnification obtained by dividing the text display height by the standard text height and (ii) the display magnification obtained by dividing the text display width by the standard text width, it is possible to display the entered texts at the maximum magnification in the middle of the text display region just by designating the text display region and entering the texts.

However, the related art has the following problem.

It often happens that users have more or less images or imageries about “which text size is suitable for entering the texts on the screen” in their minds. The text size is generally defined by the indicators which are hard to intuitively grasp, such as point number, and many processes such as changing size are often required for entering the texts at the intended size on the intended position after the texts is entered. The same thing can be said about the related art described above. Thus, since the texts is displayed in such a condition that the display magnification is changed automatically to fit the entered texts to the width or height of the display region designated by users, the text size becomes relatively small if the entered text has a relatively long length, and the text size becomes relatively large if the entered text has a relatively short length. Then, since it is difficult for users to grasp how much the display region is required depending on (i) the intended text size and (ii) the length of the text to be entered, the text size in the text input process is easily departed from the user's intention, and many processes are required to display text at the intended size.

In this manner, in case that many processes are required upon displaying the text at the intended size, for example in various events which proceed while inputting text or texts in a real time manner in front of a plurality of participants, such as a meeting, a conference, a lesson, a lecture, a seminar, a presentation etc., or in such events which proceed basically privately like material preparation, the processes itself for displaying the text at the intended size have concerns about disturbing the progress of the various events. In such a case, these events take longer, and the concentrations of participants and operators are also distracted horribly, and the efficient and effective progresses of the events may be disturbed. Namely, the related art has various types of inevitable problems which are caused by the technical issues that displaying at the intended size is difficult for users.

### SUMMARY OF THE INVENTION

To solve the problems described above, a text display control apparatus of the present invention to display a text or texts on a screen of a display device, is provided with: an identifying device for identifying, in case that a display area is set to display the text on said screen, a length in a direction, which is crossing to a display direction, of the text in said display area; a determining device for determining a size of the text to be displayed on said display area on the basis of the identified length; and a display controlling device for controlling, in case that the text is entered to said set display area, said display device to display the entered text at the determined size on the set display area.

The term “text” or “texts” of the present invention is a notion which includes a character or characters, a number or numbers and a symbol or symbols etc., which can be displayed on the screen of various types of display devices such as a plasma display devise, a liquid crystal display devise or a CRT display devise etc. In the present invention, each of characters, numbers, symbols and the combination of the characters, numbers and symbols etc., are basically expressed “text” or “texts” as a whole.

On a screen of a display device in the present invention, a display area used for entering texts, such as a text box etc, at the preferred timing for users is set by the operation with using various pointing devices including a keyboard, a touching pen or a mouse, a track ball, a touching pad or scroll button etc. The display area is made up for carrying out various operations such as “notify”, “select”, “determine or decide”, “zoom”, “drag and drop” and “move” on the screen of various applications, such as word processor, spreadsheet, presentation, database, paint, drawing, drafting, photo retouching and electric board etc. The term “display area is set” means that the display area is maintained at the state which can enter texts at least temporarily after various operations such as “notify”, “select”, “decide or determine”, “zoom”, “drag and drop” and “move” etc.

According to the text display control device of the present invention, during its operation, in case that the display area is set, an identification device identifies a length (hereinafter referred to as “target length”) in a direction (hereinafter referred to as “crossing direction”), which is crossing to a display direction, of the text in this set display area. Then, the term “display direction of the text” is, for example, an arranging direction of each character constituting the text displayed on the screen finally, and it means horizontal direction under the aspect called “horizontal writing”, and it also means vertical direction under the aspect called “vertical writing”. Then, for example, since a input direction of the text may be horizontal in vertical writing, the display direction may be not necessarily consistent with the input direction of the text. And if the length in horizontal direction is called as “width” and the length in vertical direction is called as “height” for descriptive purposes, the target length means the height under the aspect of horizontal writing, and also means the width under the aspect of vertical writing.

In contrast, according to the text display controlling device of the present invention, a determining device determines a size, for example, which can be expressed by point number, of the text to be displayed on said display area on the basis of the identified length. The term “a size of the text” means a visual size of the text on the screen, which can be expressed with quantitative indicators such as point numbers and qualitative indicators to judge whether it is larger than the standard size or not. Then, the determining device determines a size of the text continuously (seamlessly) to the extent that the size exceeds the user's cognitive resolution, or continuously or discontinuously in the form with relative fine variation width to the extent that the user's cognition is not necessarily impossible, or discontinuously in the form with relative large variation to the extent that the users can cognize enough.

“How the size of the text is determined on the basis of the identified target length” is not limited as long as the target length and the suze of the text mutually have one-to-one correspondence, one-to-multipoint correspondence, multipoint-to-one correspondence or multipoint-to-multipoint correspondence according to the predetermined correspondence relationship or judgment criterion so that the users can visually and intuitively designate the target length and the size of the text at least, and for example, the size of the text may be determined so that both sides of the text are connected with a visual or virtual frame line opposite the crossing direction in the set display area (namely, to the extent that the blank space in crossing direction decreases to zero or approximately zero), or that the intended blank space exists at the position between the frame line in the crossing direction and the text. Considering of the difference of the lengths in the crossing direction of the text parts among characters, numbers and symbols, the term “a length in a crossing direction of the text” is a value which is unambiguously determined depending on the size of one text (of course, it may be different by fonts).

In the case that multiple sizes of the text with respect to the target length are prepared or detected as candidate values, one candidate value may be selected on the basis of the judgment criterion, to be set for the user's cognitions and feelings based on experiments, experiences, theories or simulation etc. In a similar way, in the case that the size of the text is basically determined unambiguously, the size of the text may be determined as another size in the form accepting proper amendments based on the set modification processes to fit with the user's intention and feeling. Anyway, the size of the text is finally determined on the basis of the identified target length.

Furthermore, according to the text display control device of the present invention, the display controlling device directly controls, in case that the text is entered with respect to the set display area, said display device to display the entered text, at the determined size on the set display area as described above, or indirectly controls by producing display data to display on a screen, or indirectly controls via the text display function controlling of the applications which provide text input via such a display area. Thus, the term “display device is controlled” of the present invention is not necessarily provided with physical, mechanical or electric control to physical, mechanical or electric components such as a display circuit, a display unit, a driving circuit or driving unit etc, and is a notion including a physical, mechanical or electric processes and controls to display text at the determined size on the screen via display device control finally.

As explained above, according to the text display control device of the present invention, the operation for setting the display area (for example, the drag operation from a starting point to an ending point of the display area using various pointing devices) does not only define the positions where the text is displayed, but also includes the operations to designate the size of the text size, and the size of the text image which users may hold in the case that the users intend to display the text on the screen can be easily embodied only by the operations to set the display area and the operation for entering the text into, for example, a rectangle display area set by the operations. Therefore, for example, the users may not need to consider the indicators, such as point number, which is difficult to understand intuitively, and can easily display the text on the screen intuitively, and the size of the text is not changed against the user's intention and feeling by the entered text length. Consequently, users can easily display the text at the intended size.

In one aspect of a text display control device of the present invention, the text display control apparatus is further provided with a modifying device for modifying the set display area by extending the set display area along to a predetermined direction, if the length in the display direction of the displayed text exceeds the display area of the displayed text as the entered text is displayed at the determined size.

According to this aspect, if the size of the display area in the process for displaying the text at the determined size (substantially and sensuously, which proceeds with the input operation) is insufficient, once the set display area is modified to expand along to the display direction of the text or the crossing direction. Therefore, users do not have to be careful about the shortage of the display area, and can freely input the text to the display area. Consequently, according to this aspect, displaying text becomes easier and efficient.

In another aspect of a text display control device of the present invention, said determining device determines the size of the text to be used for displaying among a plurality of candidate values related to the size of the text, which are set in advance.

According to this aspect, since one size can be selected from the predetermined size of the text as candidate values on the basis of the identified target length, the processing load of the determining device in determining the size of the text; is reduced.

The larger the number of these candidate values is, the more fine the size of the text changes, but it is possible to strict the number of the candidate values within the necessary extent on the basis of the experiments, theories or simulations without holding practical concerns for users. In such a case, the high profit that satisfaction for users can be substantially provided and the processing load can be reduced is provided.

In this aspect, the text display control device is further provided with an assigning device for assigning, with respect to the candidate values, an application range corresponding to a length in the direction, which is crossing to the display direction, of said text on said display area, wherein said determining device determines the candidate value to which the corresponding application range is assigned as the size of the text to be displayed if the identified length corresponds to the assigned application range.

For example, in the case that multiple display areas are sequentially set and users have intentions to enter and display the text belonging to the same category (for example, minutes) sequentially, it is not at least unnatural for users to have intention to unify the size of the text into one. However, if users intend to set multiple display areas to have mutually same configurations to display the multiple texts at mutually same sizes, it is practically more natural to contain some error. Then, if the size of the text is seamlessly determined to be mutually different in the form linearly depending on the error which is caused by such these artificial operations, the form of the displayed text is easy to lose touch with the intentions or feelings of the users.

According to this aspect, an assigning device for assigning, with respect to each of a plurality of the candidate values, an application range corresponding to a length in the crossing direction on said display area, and said determining device determines the candidate value to which the corresponding application range is assigned as the size of the text to be displayed if the identified length corresponds to the assigned single or multiple application range.

Therefore, it become possible to relatively increase (Namely, since more accurate operations are required when users set an input area, the state in which the size of the text is set more accurately is adopted) or decrease (Namely, although the size of the text changes become somewhat discontinuous, the state in which the operation error in user's input area setting is tolerated much more is adopted) the sensitivity to the determined size of the text corresponding to the identified target length depending on the number of candidate values (namely, the substantial number of options) which the assigning device targets and the application range scale (for example, the height range of the display area used for displaying the text at same size) which assigns to the targeted candidate values.

The term “assign” of the present invention does not only mean matching candidate values to application range in real-time, but also means loading and referring the existence of the candidate values to which the application range is assigned and the assigned application range via proper access to these storage device in the state that lists and maps preliminary describing at least the correspondence relationship between the candidate values and the application range are recorded in various rewritable storage device such as RAM (Random Access Memory), Flash memory, USB memory HDD (Hard Disk Drive) or Buffer memory, or in various un-rewritable memory device such as ROM (Read Only Memory), and the physical, mechanical, electric or software-like processes are not limited as long as the size of the text determined by the determining device, always or in the case that any condition are satisfied, is carried out from the candidate values to which this application range is assigned. Therefore, as one preferred aspect of the assigning device, an application range is assigned to a part of the candidate values in a default state, and then the number of the candidate values to which the application range is gradually assigned by reflecting the user's operations and the assigned application range can be arbitrarily changed by writing or deleting in the storage device described above, for example.

As an example of an assigning aspect of such a assigning device, if the application ranges is set with respect to the all candidate values so that the application ranges do not mutually overlap and do not continue with the neighboring application ranges, one candidate value is unambiguously selected according to the identified target length, and the size of the text can be determined as continuously as possible. And if application ranges are set not to mutually overlap and to be continuously continued with the neighboring application range, the decided size of the text, which is the same as the point that one candidate value is unambiguously selected with respect to the identified target length, can be at least discontinuously determined corresponding to the size relationship between the candidate values to which the application ranges are assigned without user's perception.

Thus, according to this aspect, the sensitivity to the determined size of the text of the display area's configuration (for example, length in crossing direction) can be changed with the number of the candidate values providing application ranges and application range size (when the application range is decided to mutually and continuously overlap, these affect each other) by the assigning device, and although relatively small error which may be produced during the artificial operations is contained, the effect for the determined size of the text can be eliminated as much as possible. Consequently, displaying the text according to the user's intention and feeling becomes possible.

As described above, the aspects for selecting candidate values and assigning application ranges eliminate the possibility to misjudge the operational error as user's intention, and in the case that users want a different size of the text with obvious intention, the corresponding size of the text may be preliminarily determined to display at the size based on various experiments and simulations which are carried out from the view of human engineering. And it is constituted to be arbitrarily changed by reflecting the user's intention with operating the proper operation device.

Furthermore, from the viewpoint for accepting remarkable profits of the present invention that the size of the text is automatically determined corresponding to the length in the direction crossing to the display direction of the text in input area (namely, corresponding to user's intention, ideally), the compensation of input error by these assigning device can be executed as a part of the function provided with the text display controlling device of the present invention only if the users selects the function.

In one aspect of the text display control device provided with an assigning device of the present invention, said assigning device assigns the application range as a range obtained by adding or subtracting, with respect to the candidate value corresponding to the size of the text determined in the past among the candidate values, a given tolerance onto or from the length in the direction, which is crossing to the display direction, of the texts.

The input of the text and displaying the text, which is made by users, are the events which can randomly occur on the time-line, but it is rare that each of them has a mutually different size of the text. In particular, the tendency is remarkable for displaying the text on one screen. For example, in the case that information, opinion, instruction or question etc are written in the image displayed on the screen at a presentation, conference, meeting etc, it is likely that the size of the text is unified or systematically set.

According to this aspect, an assigning device assigns the application ranges, which is described above, only with respect to candidate values corresponding to the size of the text determined in the past out of the candidate values, namely, which are the size of the text (as a preferred aspect, the size of the text already displayed on a screen) fitting to user's intention and feeling in the past, or to those candidate values by priority.

In such a case, an assigning device sets the application ranges including the length in the crossing direction by adding or subtracting a given tolerance onto or from the length (namely, height in horizontal writing) in the direction, which is crossing to the display direction, of the texts (namely, text corresponding to the text size decided in the past). The tolerance means, for example, a value at which there is a high possibility that users want the size of the text, and when the possibility that the operational error in setting display area is misjudged as user's intention is eliminated as much as possible and users want the different size of the text in obvious intention, the tolerance may be determined according to the judgment criterion determining on the basis of various experiments and simulation carried out from the human engineering point of view. Therefore, as a preferred aspect of this aspect, the application ranges are mutually discontinuous. The tolerances may be mutually different in the additional side and the subtract side, or may be also equal.

Thus, according to this aspect, it is possible to easily carry out the determination based on the length of the display area in the crossing direction, and the user's spiritual, physical or time load can be reduced in the case that it is practically used by users.

In another aspect of a text display control device of the present invention, the determining device determines as a size of the text to be displayed, a size of the text which is maximum in a range that a difference between the identified length and the length in the direction, which is crossing to the display direction, of the text is larger than a given value.

According to this aspect, it is possible to display the text as large as possible with the intended blank space in crossing direction. Therefore, the operation for displaying the text at the intended size become more intuitive, its convenience can be increased. If the given value is zero, the text has a contact with the side in the crossing direction of the display area, and the size of the text is relatively freely determined, depending on the given value setting.

The given value may be set variable by the operation of user's side, and in such a case, it also becomes possible that users set the relative relationship between the operation for setting the display area and the determined size of the text. Therefore, since users can adjust the determined size of the text to fit with their sensitivity, it is effective.

In another aspect of a text display control device of the present invention, a first notifying device notifies the size of the text corresponding to the length in the direction, which is crossing to the display direction, of the text on the display area in the process in which the display area is set.

According to this aspect, the size of the text corresponding to the length (namely, length in crossing direction) in the direction crossing to the display direction of the text on the display area is called as a displayed visual information, character information or voice information etc by a first notifying device in the process setting the display area as a notion including a point when the display area is set, a period for setting the display area or time range after the display area setting.

The term “size of the text corresponding to the length in the direction crossing to the display direction of the text on the display area” indicates the size of the text estimated to be determined by a determining device in completing the display area setting at the point, so-called, which is an active size of the text at the current point.

The information provision is effective as supplementary information for making users learn the corresponding relationship between the size of the display area and the size of the text determined by a determining device if the text is easily and intuitively displayed without the information provision.

The physical, mechanical, mechanistic or electric configuration of a first notifying device is not limited as long as the active size of the text to be used for the displaying at the present point is notified to users by displaying such a visual information and character information on the screen, or by providing users with voice information. For example, a first notifying device includes at least a device to produce data used for displaying corresponding to the above visual information and character information, and may notify the size of the text by providing the display device with the data used for the display, or by controlling a display device to display the produced visual information and character information.

In another aspect of a text display control device of the present invention, a second notifying device notifies the size of the text determined in the past.

According to this aspect, the text size decided in the past, namely, which is the size of the text fitting to the user's intention and feeling in the past (the preferred aspect is the size of the text already displayed on the screen), is called as visual information, character information or voice information by a second notifying device. Therefore, user's side can follow the size of the text which is determined in the past and used for displaying at the present time from now to the future, and displaying the text can be effectively carried out.

The aspect of a notifying of the second notifying device is not limited as long as the size of the text determined in the past can be notified to users, but according to the fact that it is more effective that users can intuitively grasp the relative relationship on the text determined in the past, as the notifying of a first notifying device, it is relatively difficult to show the effects in the information (for example, character information such as “the size of the text used in the past is xx point.”) based on the indicators which is difficult to say intuitive, such as point number. Then, as a preferred aspect, in the process for setting the display area, when the configuration of a display area is consistent with that used for displaying the text in the past or the size of the text becomes the configuration at the size of the text used in the past, a second notifying device may notify directly or indirectly via the preferred device control so that the display color of the display area is changed or the frame of the display area is blinked.

The physical, mechanical, mechanistic or electric configuration of a second notifying device is not limited as long as the size of the text (when the text is displayed as-is, namely, the size of the text displayed in the past without considering whether it is displayed at the present point or not) determined in the past is notified via visual effect on the screen. For example, the second notifying device may make notifying indirectly via the display controlling device to provide a display controlling device with commands and control signals so that visual effect, which is described above, for the display area in the setting process is given, or by directly controlling the display device in the form of temporally taking over the control of the display controlling device.

### <Computer Program>

To solve the above problems, a computer program of the present invention make a computer system function as the text display control apparatus (including its various aspects) described above.

According to a computer program of the present invention, the text display control apparatus of the present invention can be relatively easily achieved by executing a program which is read from a record medium storing the computer program, such as ROM, CD-ROM, DVD-ROM, Hard-Disk, or by executing the program after downloaded onto the computer system via a communication device.

A computer program of the present invention can also include various aspects corresponding to the above-mentioned various types of the text display control apparatus.

To solve the above problem, a computer program product in a computer-readable medium can tangibly embody computer program commands executable by a computer and can make the computer function as the above-mentioned text display control apparatus (including its various aspects).

According to the computer program product, the above-mentioned text display control apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer system, or by downloading the computer program product, which may be a carrier wave, into the computer system via a communication device. More specifically, the computer program product may include computer readable codes to cause the computer (or may comprise computer readable instructions for causing the computer) to function as the text display control apparatus of the present invention described above.

As explained above, since the text display control apparatus of the present invention is provided with the identifying device, the determining device and the display controlling device, the text can be easily displayed with the intended size.

As explained above, since the computer program of the present invention can function the computer system as the text display control apparatus of the present invention, text can be easily displayed at the intended size.

The effects and other profits of the present invention will be clearly apparent from the following detailed description.

### BRIEF DESCRIPTION OF THE DRAWINGS

FIG. 1 is a conceptual block diagram showing a configuration of a personal computer (PC) according to a first embodiment of the present invention;

FIG. 2 is a block diagram of a control device of a PC in FIG. 1 when an application recorded in the PC in FIG. 1 is executed;

FIG. 3 is a flowchart of a text display process appropriately executed during the execution of an application;

FIG. 4A, FIG. 4B and FIG. 4C are schematic diagrams showing a display image during the execution of a text display process;

FIG. 5 is a flowchart of a text display process according to a second embodiment of the present invention;

FIG. 6 is a schematic diagram of a text size list referred in a text display process in FIG. 5;

FIG. 7 is a flowchart of a text display process according to a third embodiment of the present invention;

FIG. 8 is a schematic diagram of a text size list referred in a text display process in FIG. 7;

FIG. 9A, FIG. 9B and FIG. 9C are another schematic diagrams showing a display during the execution of a text display process

### DETAILED DESCRIPTION OF THE PREFERRED EMBODIMENT

Hereinafter, preferred embodiments of the present invention will be explained with reference to the drawings.

### First Embodiment

Hereinafter, a personal computer (hereinafter referred to as a “PC” appropriately) 100 will be appropriately explained with reference to the drawings.

### <Structure of Embodiment>

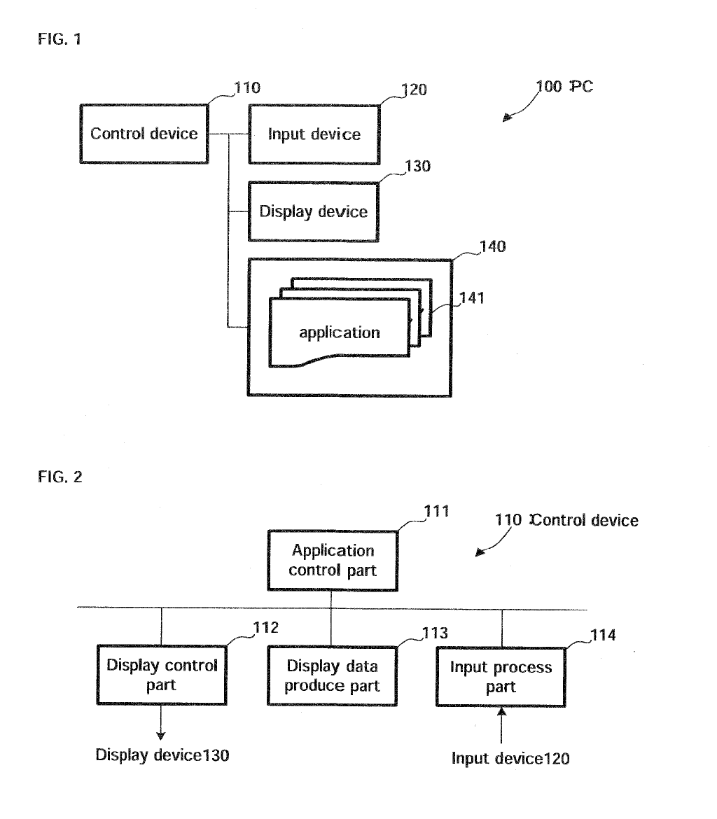

At first, with reference to FIG. 1, the structure of a PC 100 will be explained. FIG. 1 is a conceptual block diagram showing the structure of a PC 100.

In FIG. 1, a PC 100 is provided with: a control device 110; an input device 120; a display device 130; and a storage device 140, and is a computer system used by users who are not shown in the drawing.

The control device 110 is provided with a buffer memory such as CPU (Central Processing Unit), MPU (Micro Processing Unit) etc., and is a control unit which can control the total performance of the PC 100. The control device 110 is constructed to function as one of a “text display control apparatus” of the present invention by executing an application 141 which is described below.

The input device 120 appropriately includes a pointing device or devices (which are not shown in the drawing) such as a keyboard, an input pen, a mouse etc, and is constructed to carry out the operations for entering by users.

The display device 130 is one of various types of display devices such as a plasma display device, a liquid crystal display devices etc., and can display the image (which is an example of the “image” in the present invention, and hereinafter referred to as “application image” appropriately) related to an application program 141 (hereinafter referred to as “application” appropriately) executed by the control device 110.

The storage device 140 is the memory device provided with a nonvolatile relatively-large-sized recording medium such as HDD etc. On the storage device 140, multiple application programs (hereinafter referred to as “application” appropriately) are memorized or recorded. The application 141 is the computer program belonging to various categories such as a word processor, a spreadsheet, a presentation, a data base, a painting, a drawing, a photo retouching or a electric blackboard etc, and is constructed to carry out various functions corresponding to the user's operations on the application image unique to the executed application by executed by the control device 110. Namely, each of the application 141 is an example of “computer program” of the present invention.

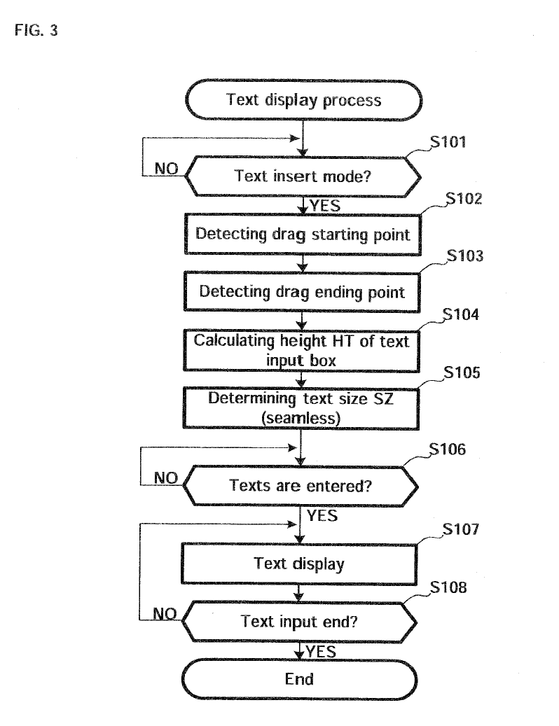

The control device 110 functions as software-like multiple function blocks by executing the application 141. Then, with reference to FIG. 2, the function blocks of the control device 110 during the execution of the application 141 will be explained. FIG. 2 is a block diagram of the control device 110 during the execution of the application 141. In this figure, same reference numerals are marked at the same parts in FIG. 1, and the explanations thereof will be appropriately omitted.

In FIG. 2, the control device 110 is provided with: an application control part 111; a display control part 112; a display data produce part 113; and an input process part 114.

The application control part 111 is the main function block to unify the operations of the application 141, and is an example of the “identifying device” and the “determining device” of the present invention, which is constructed to control the display control part 112, the display data produce part 113 and the input process part 114 by priority or on the higher level, respectively.

The display control part 112 is the function block which is constructed to control the display state of the application image of the display device 130, and is constructed to function as an example of the “display controlling device” of the present invention.

The display data produce part 113 is the function block for producing the display data related to the application image displayed on the display device 130, and constitutes an example of the “display controlling device” of the present invention with the display control part 112.

The input process part 114 is the function block which is constructed to obtain and analyze signals corresponding to the user's operation of the input device 120 via the input device 120, and constitutes an example of the “identifying device” of the present invention with the application control part 111.

### <Operation of Embodiment>

The application 141 is provided with a text insert mode in which texts including characters, numbers or symbols etc (hereinafter, these combination and each of them all are expressed as “texts”) at the intended position of the application image as one function. The process for displaying texts in the text insert mode is different from the standard text display process (which is the text input from the viewpoint of users) of the application 141 (for example, the process for entering sentences by using mainly a keyboard in a word processor, or the process for entering mainly numbers and items by a keyboard for table calculations).

In the present embodiment, the operation for displaying texts in the text insert mode is executed via a text input box (namely, an example of the “display area” in the present invention) which appears on the application image when the switches corresponding to the text insert mode are selected from various types of software switches (for example, one option of a main menu, a sub menu or a pull-down menu etc., or visible switches such as icons or buttons etc in the application image (for example, which may be formed as a window) of the application 141) which is expanded on the application image. In the text insert mode, the execution state is controlled by “text display process” which is executed by the application control part 111, which is explained below.

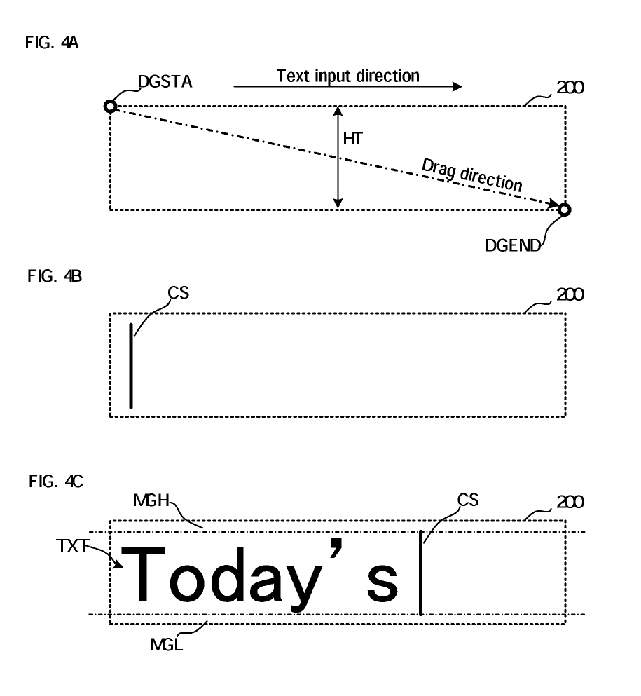

With reference to FIG. 3, FIG. 4A, FIG. 4B and FIG. 4C, a text display process will be explained in detail. FIG. 3 is a flowchart of a text display process. FIG. 4A, FIG. 4B and FIG. 4C are schematic diagrams showing an application display image during the execution of a text display process. In this aspect, from the purpose to prevent the explanation from complicated, it is supposed that a user uses a keyboard to input the texts and a mouse to operate the position designation on the application image and various software switches, respectively. The device used by the user may be any device constituting the input device 120 as long as the same operation can be carried out.

In FIG. 3, the application part 111 makes judgment whether the text insert mode is selected or not (STEP S101). The input device 120 provides the input process part 114 with signals corresponding to the operations when the input device 120 is operated by users. The application control part 111 obtains electric signals or electric signals corresponding to the user's operations analyzed on the basis of the electric signals from the input process part 114, and controls the display data produce part 113 and the display control part 112 to execute the functions corresponding to the user's operations.

For example, if users operate the mouse to move the mouse pointer to the intended position on the application image, the input process part 114 calculates the display position of the mouse pointer which is unambiguously determined by the quantity and direction of the user's operations based on the electric signals provided from the mouse. The application control part 111 controls the display data produce part 113 and the display control part 112 to display the mouse pointer at the position displaying the application image corresponding to the provided position data. Consequently, the mouse pointer is displayed at the position of the application image designated by the users. The process is repeatedly executed by very short interval to the extent that the users cannot perceive, and the mouse pointer is continuously moved and displayed on the application image basically.

For example, if users carry out various operations (for example, “click”) such as selecting, deciding etc. to any software switches displayed on the application image by using a mouse, the input process part 114 analyzes the contents of the operations, and provides the application control part 111 with the electric signals corresponding to the analyzed operations. In the process of STEP S101, the application control part 111 makes judgment whether the text insert mode is selected or not, as a part of the operations of the input process part 114 when the electric signals indicating that the software switches promoting the execution in the above-mentioned text insert mode is provided. If the text insert mode is not selected (STEP S101: NO), the application control part 111 repeats the process of STEP S101, and controls the process to remain the waiting state.

In contrast, when the text insert mode is selected (STEP S101: YES), the application control part 111 identifies a drag starting point DGSTA (STEP S102). The drag starting point DGSTA is the starting point of the text input box 200. When the drag starting point DGSTA is detected, the application control part 111 further identifies a drag ending point DGEND (STEP S103).

As shown in FIG. 4A, a drag starting point DGSTA and a drag ending point DGEND are an upper-left summit and a bottom-right summit, respectively, in the rectangle text input box 200 (see the broken line). The practical operations in setting the text input box 200 involve the operations such as that the mouse bottom is push down (or clicked) at the drag starting point DGSTA, and the mouse is operated to make the mouse pointer moved along to the illustrated drag direction with maintaining the pushed down state (in the case of click, the pushed down state is not necessary), and the pushed down state is released at the intended drag ending point DGEND (or clicked again), and after the setting operations of these various aspects, the text input box 200 illustrated in FIG. 4A is displayed on the application image.

The display control of the text input box 200 is carried out by the application control part 111. Namely, unless the text insert mode is released for any reason when the text insert mode is selected, the input process part 114 produces positioning data related to the display position of the drag starting point DGSTA depending on the mouse operations in designating the drag starting point DGSTA, and provides the application control part 711 with the data. In a similar way, the positioning data related to the display position of the drag ending point DGEND is produced in response to the mouse operations in designating the drag ending point DGEND (namely, drag direction is also considered at this point), and is provided to the application control portion 111. After deciding the drag starting point DGSTA, the present position of the mouse pointer is treated as a tentative drag ending point DGEND. Until the operations for designating the drag ending point DGEND (namely, the conclusive drag ending point in the sense contrast to the tentative drag ending point) is carried on, the positioning data of the tentative drag ending point DGEND is consecutively provided to the application control part 111 in the similar manner as the above-mentioned movement display of the mouse pointer. The process of the STEP S102 and STEP S103 is completed in the process in which the positioning data is provided.

The application control part 111 starts to display the tentative text input box 200 depending on the positioning data corresponding to the tentative drag starting point DGSTA (namely, displaying the text input box 200 at the present point when the drag ending point DGEND is not determined yet, via the control of the display data produce part 113 and display control part 112), and after that, controls the display data produce part 113 and the display control part 112 to display the form of the tentative text input box 200 continuously changing corresponding to the changes in the tentative drag end point DGEND. Namely, the period during which the tentative text input box 200 is displayed is an example of the “process to set display area” of the present invention.

When the operations for designating the drag ending point DGEND by users are carried on during displaying the tentative text input box 200, the abovementioned positioning data including the contents is provided from the input process part 114 (namely, the process of STEP S103 is executed at this point), and the application control part 111 displays the application image in the text input box 200 where the display aspects (for example, display position, form, display color, display effect etc) are determined. FIG. 4A shows a text input box 200 where a display aspect is determined.

The positioning data of the tentative drag point DGEND is not necessarily provided to the application control part 111 (in this case, the positioning data itself of the tentative drag end point does not have to be produced). After the positioning data of the drag starting point DGSTA is provided, the application control part 111 may wait until the positioning data which follows with the operations in designating the drag ending point DGEND is provided, or until the text insert mode is released (namely, until the text display process is forcibly terminated). In this case, since the process for displaying the mouse pointer is carried on, the practical difficulty in estimating the display aspects of the text input box 200 is not occurred.

The positioning data related to the tentative drag ending point DGEND is provided, and the tentative text input box 200 may not be displayed. In this case, the application control part 111 may control the display data produce part 113 and the display control part 112 to display any information supporting the user's operations such as displaying the segments from the drag starting point DGSTA to the tentative drag ending point DGEND (namely, the segments corresponding to a diagonal of the tentative text input box 200) instead of the display of the tentative text input box 200. The positioning data related to the provided tentative drag ending point DGEND may be merely buffered so as to rapidly carry out a calculation process which is generated later.

When the text input box 200 is displayed, the application control part 111 calculates height FIT (Hereinafter, referred to as “box height HT”) of the text input box 200 (STEP S104). The box height HT is the length in the direction (hereinafter referred to as “height direction”) perpendicular to the allowed text input direction (namely, one example of the “crossing” in the present invention) in FIG. 4A, and an example of the “length in the direction crossing to the display direction of the text” of the present invention. In this embodiment, the text input direction is usually a horizontal direction shown in the drawings, and the text display direction (i.e., the display direction of the text) has one aspect which is one of “vertical writing” and “horizontal writing” and which is selected by the input device 120 before or after the execution of the text display process. In this embodiment, horizontal writing is selected, so that the text input direction and the text display direction are identical to each other.

In the process of the STEP S104, the application control part 111 calculates the box height HT on the basis of the positioning data already provided in the process of STEP S102 and STEP S103, namely, as the difference (which one is subtracted is appropriately selected depending on the setting aspect of the coordinate) between the vertical coordinate of the drag starting point DGSTA and the vertical coordinate of the drag ending point DGEND. In this embodiment, since the positioning data corresponding to the above-mentioned tentative drag ending point DGEND is provided, the calculation itself of the box height HT may be carried out in the phase before the drag ending point DGEND is determined. Namely, in this case, the tentative box height HT may be continuously calculated depending on the user's mouse operations. When the tentative box height HT is recorded in the proper memory device such as RAM, the process of STEP S104 may only obtain box height HT from the memory device.

After calculating the box height HT, the application control part 111 determines a text size SZ which is a size of texts displayed in the set text input box 200 (STEP S105). After deciding the text size SZ, the application control part 111 controls the display data produce part 113 and the display control part 112 to display a cursor CS for deciding the text display position and promoting text input to the set text input box 200. Consequently, a cursor CS is displayed in the text input box 200, and getting a state waiting for text input. FIG. 4B shows the state waiting for the text input.

When the text size SZ is determined, the application control part 111 selects one text size among the prepared multiple candidate values so that the text height (namely, which is each height of characters, numbers or symbols etc constituting the text, and all of them are equal in one text size (the length between the upper side and the lower side is not necessarily equal)) has a maximum peak in the range below the upper limit value which is lower than the calculated box height HT by the value corresponding to the margin MG, and determining as the text size SZ. Then, if the text size is expressed in point number, the candidate values of text size are prepared in the range of 1-1500 point with 0.5 point interval, and the decided text size SZ is seamlessly decided essentially depending on the value of box height HT. The height corresponding to each of the candidate values of the text size is recorded in ROM.

The value of margin MG which determines the upper limit value can be designated from the input device 120 in tandem of the execution of the text display process. If there is no designation from users, a margin MG is set to zero which is a prepared default value. Namely, the upper limit value is a box height HT in the default setting state, and the text size SZ is decided to be maximized in the range lower than the box height HT. As described above, the candidate values of text size are adequately segmented in practice, and the text size which has an equivalent height with the nearly upper limit value is selected as the text size SZ.

In the state waiting for text input, the application control part 111 makes judgment whether texts are entered or not (STEP S106). Since the operation for entering texts is carried out with a keyboard as described above, the application control part 111 makes judgment whether electric signals which show the operations with the keyboard of the input process part 114 is provided or not. If texts are not entered (STEP S106: NO), the application control part 111 repeatedly executes the process of STEP S106.

The input process part 114 analyzes which key has been pushed down on the basis of electric signals which can identify each key entered from the keys operated in the operating keyboard, and provides the application control part 111 with the control signals to call the operated keys. When the fact that texts is entered by obtaining the control signals (STEP S106: YES) is discerned, the application control part 111 controls the display data produce part 113 and the display control part 112 so that the text TXT corresponding to the operated key is displayed at the text size SZ decided in the process of STEP S106 (STEP S107). Consequently, the text TXT is sequentially displayed in the text input box 200 depending on user's input operations via a keyboard. FIG. 4C shows a text input box 200 in which text TXT is entered and displayed by this means.

In FIG. 4C, margin MGH and margin MGL are located above and below the text, TXT, respectively. The value of these margins MGH and MGL are calculated by the application control part 111. Then, the application control part 111 subtracts text size SZ from box height HT, deciding the value of each margin by dividing the subtraction result half (namely, the quantity corresponding to the margin MG described above). FIG. 4C shows that text TXT is displayed at the upper and the lower end of the text input box 200 with the margin MGH and MGL, respectively.

After displaying the entered text, the application control part 111 makes judgment whether the text input has been finished or not (STEP S108). When the text input continues (STEP S108 NO), the application control part 111 calls back the process to STEP S107, and sequentially displaying the entered text on the text input box. In contrast, when the text input is finished (STEP S108 YES), the application control part 111 ends the text display process.

As explained above, according to the text display process of the present embodiment, as the height HT of the text input box 200 and the text size SZ used for practical displaying are mutually related, the designation of the text size SZ can be extremely intuitive. Thereby, users can practically set the text input box 200 on the application image according to the displayed image which the users hold in each case based on the displayed contents of the application image, the size of the application image, or attribution, appeal degree and priority of the inserted texts etc, and can display texts at the intended size on the intended position only by the execution of the text input. Namely, physical, spiritual and temporal loads are remarkably reduced, and displaying text at the intended size on the application image becomes possible easily.

Thus, considering to the fact that loads in displaying the text at the intended size are remarkably reduced, for example, at various events which proceed with real-time text input in front of participants, such as a meeting, a conference, a lesson, a lecture, a seminar, a presentation etc, or which proceed basically privately like a preparation of materials, the deciding process of text size which is essentially indifferent from the progress in this type of events prevents the concentration of users and participants of the events (for example, participants at a meeting and students in a class) from being distracted. These types of events can proceed efficiently and effectively.

The effect of these present embodiments, for example, which it is difficult to obtain when text size is set via the process (namely, which is tend to accompany with tests) which is hard to intuitively grasp the display state such as the designation of point number, or when text size changes against the user's intention depending on the length of the entered text, is a unique effect for the present invention.

The configuration of the text input box 200 is not necessarily limited to a rectangle shape as long as texts can be entered and users can grasp the decided text size SZ.

The concept of the margin MZ is not necessarily required in deciding the text size SZ. There is no problem for users to decide the text size SZ just on the basis of the box height HT.

In the present embodiment, the text input and display are carried out in the text insert mode which is one of the functions of the application 141, but such an independent application that can achieve the text input and the text display may be constituted. In such a case, the text display function corresponding to the text insert mode may function by added to a general application in the form appropriately combined into the general application.

Text size SZ may not be necessarily decided by selected from the candidate values prepared like this. For example, the text size SZ may be decided to the value fitting (preferably consisting) to the text height defined by box height HT and margin MG, not depending on whether a corresponding the text size preliminary exists in the candidate values or not. Then, if the decided text size does not exist in the candidate values, displaying the texts (namely, more accurately seamless text display) at the decided text size may be achieved by modifying the outline of the candidate value closest to the decided text size.

In this embodiment, as described above, the positioning data related to the tentative drag end point DGEND is continuously (at least with short cycle to the extent that users can cognize continuous timing on the temporal axis) provided to the application control part 111. Therefore, the application control part 111 can calculate the tentative text size SZ by executing the process equivalent to the process of STEP S104 and STEP S105 to the text input box 200 (namely, tentative text input box 200 described above) in the setting process in which the height and the width appropriately change in response to the user's mouse operations. Then, as a preferred aspect, the tentative text size SZ may be displayed on the application image as information such as “the text size corresponding to the present text input box size is xx point.” by controlling each part of the application control part 111. Namely, the application control part 111 may function as an example of “first calling device” of the present invention.

If the tentative text size is called, for example, as point number, it is difficult to accurately image the practical text size (namely, the image displayed on the application image) at user's side, but it is possible to make user's side learn “the thing I am imagining is xx point size.” by fitting the intuitively decided text size SZ in the process described above with the numerical text size, and it is effective as information at least. When calling the tentative text size, the application control part 111 can also control the display data produce part 113 and the display control part 112 to display the sample texts provided with the tentative text size within the text input box 200. In such a case, it is preferred to support the user's intuitive designation of text size.

### Second Embodiment

In the first embodiment, text size SZ was essentially seamlessly determined depending on the height of the text input box 200. Therefore, since the mouse operations of users are artificial operations, if the text input box 200 is set to display the texts at the same size, there are possibilities that the text size SZ is imperceptibly different from each other. The second embodiment which can deal with such problems in the present invention will be explained.

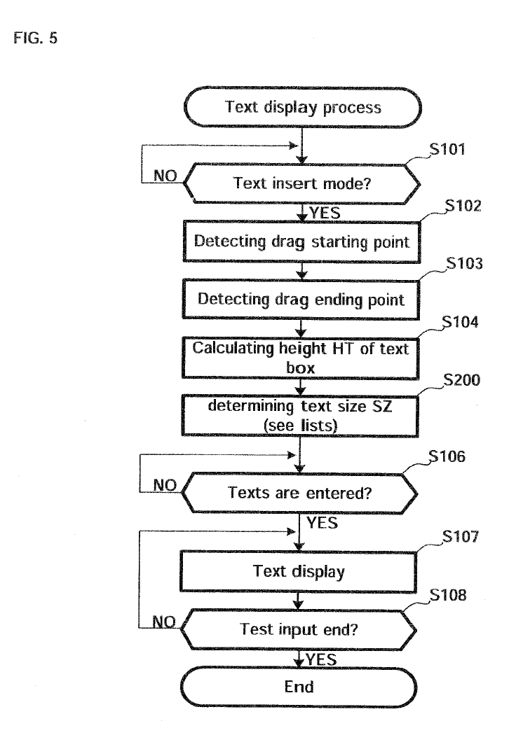

At first, with reference to FIG. 5, a text display process of the second embodiment will be explained. FIG. 5 is a flowchart of a text display process of the second embodiment. In this figure, same reference numerals are marked at the same parts in FIG. 3, and the explanations thereof will be appropriately omitted.

In the FIG. 5, when calculating box height HT (STEP S104), the application control part 111 determines text size SZ based on the box height HT (STEP S200). Then, determining the size of the text SZ in STEP S200, which is different from the first embodiment, uses a text size list SZL1 which is preliminarily set and recorded as a fixed value in ROM or as an updatable value in RAM.

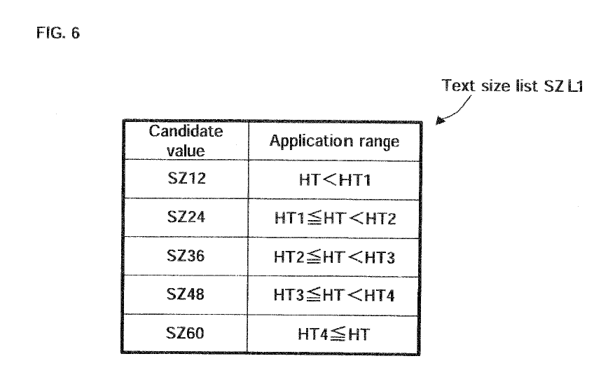

With reference to FIG. 6, the text size list SZL1 will be explained in detail. FIG. 6 is a schematic drawing of a text size list SZL1.

In FIG. 6, the text size list SZL1 is a list in which the application range is decided corresponding to the candidate values of text size. FIG. 6 sets five types of candidate values including text size SZ12, 24, 36, 48 and 60 corresponding to 12, 24, 36, 48 and 60 points corresponding to 12 points.

The application range corresponding to the box height HT is determined in the five types of candidate values so that the box height HT corresponds to at least one value not depending on the box height HT, and as shown in the figure, the text size SZ12 is applied in the range where box height HT is less than HT1, the text size SZ24 is applied in the range where box height HT is more than HT1 but less than HT2 (HT2>HT1), the text size SZ36 is applied in the range where box height HT is more than HT2 but less than HT3 (HT3>HT2), the text size SZ48 is applied in the range where a box height HT is more than HT3 but less than HT4 (HT4>HT3), the text size SZ60 is applied in the range where a box height HT is more than HT4. Namely, in the present embodiment, the application control part 111 also functions as an example of “assigning device” of the present invention.

For example, if the box height HT is calculated as HT1′ (HT<HT1′<HT2) in STEP S104 of FIG. 5, the text size decided in STEP S200 results in the text size SZ24 (namely, the text size corresponding to 24 points). When the box height FIT which users set to follow the prior text size SZ at the next text insert timing (namely, by using the different text input box 200) is HT1″(HT1′<HT1″<HT2), the text size SZ is also set as text size 24.

Since the text size SZ of the second embodiment is determined according to the text size list SZL1 decided to reduce the sensitivity to the text size SZ for the changes of the text input box 200, users following the prior text size may set the text input box 200 to the extent of the prior text input box 200. Namely, according to the decided aspect of the text size SZ in the second embodiment, such a case that the text size SZ is against the user's intention for excessively following the user's intention can be prevented from happening while maintaining the unique effect on the present invention that users can intuitively designate text size, and can reduce the physical or spiritual load which is provided of the users.

The candidate values and the application range of the text size list SZL1 may be appropriately flexible via the input device 12, namely, by reflecting the user's intention. For example, if the five types of candidate values shown in FIG. 6 go short, the number of the candidate values may be increased or decreased. The application ranges may be also set redundantly, or each application range of the mutually neighboring candidate values may not be continued mutually. When the application ranges of the candidate values are set, the display data produce part 113 and the display control part 112 may be controlled to display the information such as “which do you like, xx points or yy points?” in practically determining the text size SZ. When the application ranges of each candidate values mutually neighboring are not continued, namely, the corresponding text size cannot be determined on the text size list, the application control part 111 may control the each part to set the emergency text size, which is preliminarily prepared for such a case as the text size SZ.

If the text size SZ has a multi-to-one correspondence to the box height HT, the text size height of the text size SZ may have a possibility to inevitably become larger than the box height HT. The case does not have the practical problem of the text input and display, but may give users discomfort. According to these possibilities, the upper limit value of the application ranges corresponding to each candidate values may be set to the text height of each candidate value. Namely, the largest text size in the range of the frame of the text input box 200 may be selected from the text size list SZL1, and decided as a text size SZ.

### Third Embodiment

The text size (namely, text size SZ) of the inserted text tends to have any correlation with the texts displayed on application image. For example, as described in the second embodiment, the use of the text size following a prior text size or used in the past tends to be desired. A preferred example in such a case will be explained in the third embodiment of the present invention.

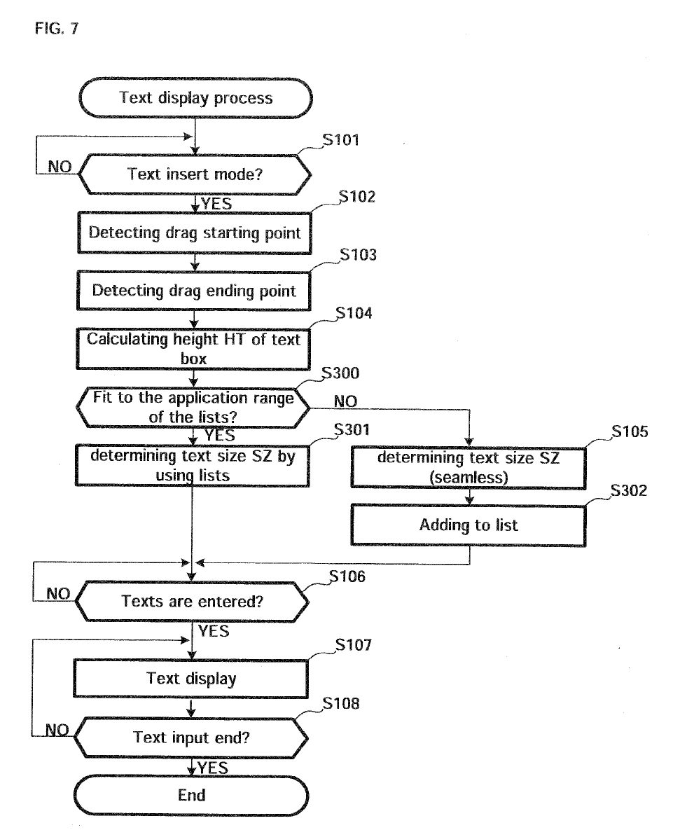

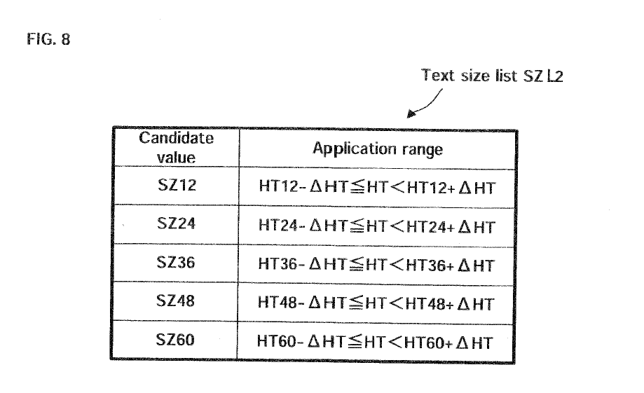

At first, with reference to FIG. 7, the text display process of the third embodiment will be explained. FIG. 7 is a flowchart of the text display process of the third embodiment. In this figure, same symbols are marked at the same parts in FIG. 3, and the explanations thereof will be appropriately omitted.

In FIG. 7, after calculating the box height HT (STEP S104), the application control part 111 refers to a text size list SLZ2, and makes judgment whether or not the calculated box height HT corresponds to the application range corresponding to each candidate value of the text size registered in text size list SZL2 (STEP S300).

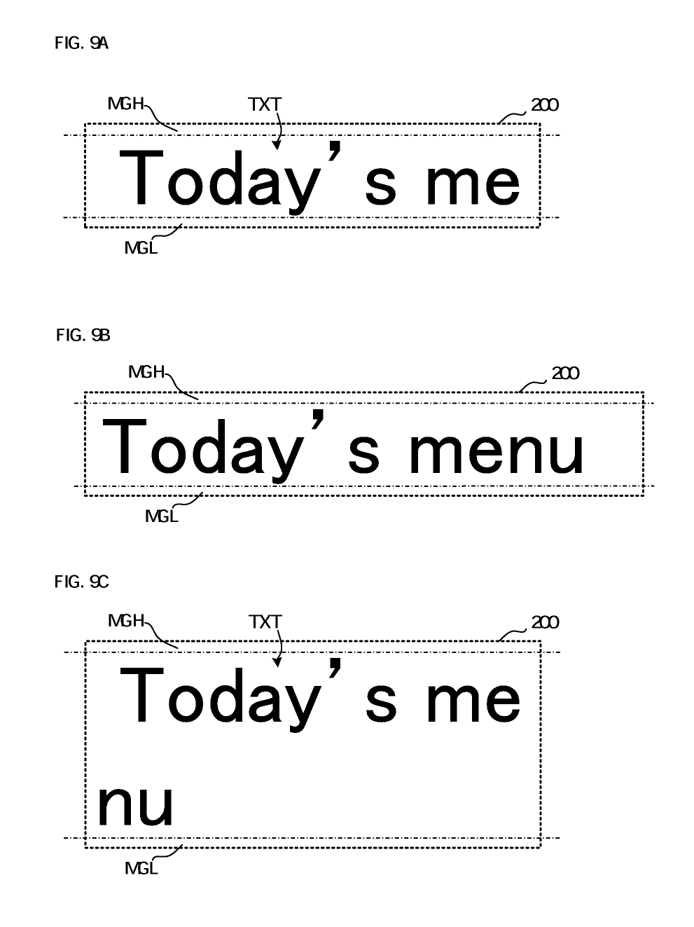

With reference to FIG. 8, a text size list of the third embodiment will be explained. FIG. 8 is a schematic drawing of a text size list SZL2. In this figure, same reference numerals are marked at the same parts in FIG. 6, and the explanations thereof will be appropriately omitted.

In FIG. 8, the text size list SZL2 is a list in which the candidate values and the application ranges are determined as same as the text size list of the second embodiment. But the each candidate value of the text size is the text size used in the past, for example, in the same data file or same page on the application image. Namely, after the application 141 is executed (preferably, after one data file of the application 141 or one page of one data file is displayed), the application part 111 registers the displayed text size SZ to the text size list SZL2 at every selecting and executing the text insert mode. Then, the application part 111 sets the ranges which are obtained by adding or subtracting a predetermined tolerance width ΔHT (namely, an example of “tolerance” of the present invention) to the text height of the registered text size (the value corresponding to text size SZxx is referred to as “HTxx” here). In FIG. 8, the candidate values are the text size SZ12, SZ24, SZ36, SZ48 and SZ60 shown in FIG. 6, but the application ranges corresponding to them are respectively different from the text size list SZL1.

Return to FIG. 7, if the calculated box height HT corresponds to one of the application ranges corresponding to each candidate value registered in the text size list SZL2 (STEP S300: YES), the application control part 111 determines the candidate values corresponding to the application ranges as the text size SZ (STEP S301). For example, if the calculated box height HT is HT12−ΔHT, the application control part 111 makes judgment to display the texts at the text size SZ12 (namely, at 12 points) used by users in the past.

In contrast, if the calculated box height HT does not correspond to one of the application ranges corresponding to each candidate value registered in the text size list SZL2 (STEP S300: YES), the application control part 111 essentially seamlessly determines the text size SZ corresponding to the box height HT as described in the first embodiment (STEP S105).

But if the text size SZ firstly used for displaying on the application image by the process of STEP S105, the application control part 111 registers the text size SZ with the application range to the text size list SZL2. After executing the process of STEP S301 or STEP S302, the process moves to STEP S106.

Thus, in the third embodiment, the text size list SZL2 is appropriately renewed and recorded on the basis of the usage of the text size SZ. Namely, the application control part 111 functions as another example of the “assigning device” of the present invention. Then, since the application ranges determined depending on the tolerance width ΔHT are assigned to the text size SZ registered in the list, it is possible to display at the intended text size though the size of the text input box 200 is more or less different when users want to use the text size used in the past. Namely, the convenience remarkably increases.

When the text size used in the past can be recorded in a buffer memory etc., calling the text size used for displaying in the past for users by the methods different from the text size list SZL2 is also possible.

For example, if the text size SZ is essentially seamlessly determined corresponding to the box height HT, the box height HT to which one text size SZ is applied is uniquely determined to the text size SZ respectively when a margin MG is not set (including zero). The application control part 11 may control the display data produce part 113 and the display control part 112 to change the display aspect of the text input box 200 or to display any information (for example, character information of “it is determined here, and the text size of xx points used in the past will be selected”) when the tentative box height FIT is consistent with one of the recorded box height HT in the process for recording the box height HT corresponding to the text size SZ used for displaying in the past in buffer memories and setting the text input box 200 by the user's mouse operations. Namely, the application control portion 111 may function as an example of the “second notifying device” of the present invention.

Such a notification of the text size SZ used for displaying in the past is effective at the point that it is possible for users to use the text size used in the past without using the text size SZL2 excepting practical load size, but since the calling function and the deciding function of the text size using text size list SLZ2 are not mutually against, the preferred aspect may function to more reduce the user's load by mutual synchronization.

It is also possible to use the display position (for example, X coordinate or Y coordinate of the drag start point DGSTA in regarding the display as a KY coordinate plane) of the text input box 200 at the drag start point DGSTA as the method for making users more efficiently use the text size used in the past.

For example, when users desire the text display at the text size used in the past, they often have intentions to fit the size to the text neighboring from right to left or up and down. Therefore, it is possible to determine the intended text size by loading the text size SZ of the text displayed neighboring to the drag start point DGSTA or from right to left or up and down at the point when the text input box 200 setting starts or in the setting process (more preferably, before the box height HT determined).

### Fourth Embodiment

As shown in the embodiment described above, since the text size SZ is determined depending on the height HT of the text input box 200, the text input does not necessarily finish within the area of the width (namely, length in the text input direction) of the text input box 200.

With reference to FIG. 9A, FIG. 9B and FIG. 9C, the fourth embodiment of the present invention preferred in such a case will be explained. FIG. 9 A, FIG. 9B and FIG. 9C are another schematic drawings each showing an application image in a process executing a text display process. In this figure, same reference numerals are marked at the same parts in FIG. 4, and the explanations thereof will be appropriately omitted.

In FIG. 9A, entering the texts to the text input box 200 is supposed to continue (with reference to FIG. 9A). When the text length exceeds the width of the text input box 200, for example, the application control part 111 can control (namely, can control the display data produce part 113 and the display control part 112 to expand) to expand the width of the text input box 200 depending on the text length (with reference to FIG. 9B). Alternatively, the text input box 200 may be doubly constituted of the state not expanding in the width direction or maintaining the width of text input box 200 or measurably expanding the width. FIG. 9C shows the state maintaining the width. Thus, the form changes of the text input box 200 results in more effective text display. Thus, the application control part 111 may function as an example of the “modifying device” of the present invention.

In the first to fourth embodiments described above, all the text display direction is selected as the horizontal direction, namely, where horizontal, writing is selected, but the effects of the first to fourth embodiments are also kept when the vertical direction is selected. In vertical writing, the direction length crossing to the text display direction in the text input box 200 is the input direction length of the text, namely, which is the width of the text input box 200. Therefore, the corresponding value to the box height HT in the first to fourth embodiments is the box width, and the indicator referred in determining the text size SZ is the box width and the text width (the width of one character, number or symbol composing the text).

In the various embodiments described above, as the option of text insert mode the hand-writing which is effective when the input device 120 provides with pen input device such as a touching pen may be set.

As described above, according to the text display control apparatus of the present invention, the text size SZ used for displaying is determined only by the operations for setting the text input box 200, which is essentially one action. Therefore, users have feelings close to the feelings of writing the texts by pens in entering the following hand-written texts. Namely, when the hand-writing input is carried out as an example of the text input in the various embodiment described above, it is preferred that users can operate more intuitively.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

### INDUSTRIAL APPLICABILITY

A text display control apparatus and a computer program of the present invention can be used for a text display control apparatus to display the texts on the display application image of a display device. It is also used for a text display control apparatus which is mounted on various computer devises for business use or can be connected to various computer devices.

1-9. (canceled)

10. A text display control apparatus for displaying a text on a screen of a display device, comprising:
an identifying device for identifying, in case that a display area is set to display the text on said screen, a length in a direction, which is crossing to a display direction, of the text in said display area;
a determining device for determining a size of the text to be displayed on said display area on the basis of the identified length; and
a display controlling device for controlling, in case that the text is entered to said set display area, said display device to display the entered text at the determined size on the set display area.

11. A text display control apparatus according to claim 10 further comprising:
a modifying device for modifying the set display area by extending the set display area along to a predetermined direction, if the length in the display direction of the displayed text exceeds the display area of the displayed text as the entered text is displayed at the determined size.

12. A text display control apparatus according to claim 10, wherein said determining device determines the size of the text to be used for displaying among a plurality of candidate values related to the size of the text, which are set in advance.

13. A text display control apparatus according to claim 12 further comprising:
an assigning device for assigning, with respect to the candidate values, an application range corresponding to a length in the direction, which is crossing to the display direction, of said text on said display area,
wherein said determining device determines the candidate value to which the corresponding application range is assigned as the size of the text to be displayed if the identified length corresponds to the assigned application range.

14. A text display control apparatus according to claim 13, wherein said assigning device assigns the application range as a range obtained by adding or subtracting, with respect to the candidate value corresponding to the size of the text determined in the past among the candidate values, a given tolerance onto or from the length in the direction, which is crossing to the display direction, of the texts.

15. A text display control apparatus according to claim 10, wherein said determining device determines as a size of the text to be displayed, a size of the text which is maximum in a range that a difference between the identified length and the length in the direction, which is crossing to the display direction, of the text is larger than a given value.

16. A text display control apparatus according to claim 10 further comprising:
a first notifying device for notifying the size of the text corresponding to the length in the direction, which is crossing to the display direction, of the text on the display area in the process in which the display area is set.

17. A character display control apparatus according to claim 10, further comprising:
a second notifying device for notifying the size of the text determined in the past.

18. A computer program make a computer system function as a character display control apparatus for displaying a text on a screen of a display device, comprising:
an identifying device for identifying, in case that a display area is set to display the text on said screen, a length in a direction, which is crossing to a display direction, of the text in said display area;
a determining device for determining a size of the text to be displayed on said display area on the basis of the identified length; and
a display controlling device for controlling, in case that the text is entered with respect to said set display area, said display device to display the entered text at the determined size on the set display area.
